(19) United States
(12) Patent Application Publication
(10) Pub. No.: US 2010/0225070 A1
(43) Pub. Date: Sep. 9, 2010

(54) Metal laminate cylinder head gasket

(75) Inventor: Yuichi Kinoshita, Tokyo (JP)

Correspondence Address: KANESAKA BERNER AND PARTNERS LLP, 1700 DIAGONAL RD, SUITE 310, ALEXANDRIA, VA, 22314-2848, US

(73) Assignee: ISHIKAWA GASKET CO., LTD., Tokyo (JP)

(21) Appl. No.: 12/659,004

(22) Filed: Feb. 23, 2010

(30) Foreign Application Priority Data
Mar. 3, 2009 (JP) 2009-048994

(51) Int. Cl. F02F 11/00

(52) U.S. Cl. 277/592

(57) ABSTRACT

A metal laminate cylinder head gasket is formed by a plurality of metal plates laminated together to form the cylinder head gasket. An injection molded resin layer is integrally formed on one of the metal plates to surround the cylinder bore to seal therearound. The resin layer adjusts the surface pressure of the gasket around the at least one cylinder bore.

### BACKGROUND OF THE INVENTION AND RELATED ART STATEMENT

The present invention relates to a metal laminate cylinder head gasket which can reliably form a necessary surface pressure in a sealing portion of a gasket which seals around a combustion chamber bore.

Recently, with high performance, reduction in weight and the like of an engine, accuracy is required for adjustment of the thickness of a cylinder head gasket. In order to meet the above-mentioned requirement, in Japanese Patent Publication (TOKKAI) No. 2003-207049, as means for forming the surface pressure in a folded portion formed around the combustion chamber bore, if a shim is clamped in the folded portion, it is difficult to easily adjust the thickness with accuracy. As a result, it was proposed to provide means forming a surface-pressure adjusting portion by applying a coating material to at least one of either an inner face side of the folded portion or a plate face which faces the inner face side, and sandwiching the coating material by the folded portion.

However, in the application of the foregoing coating material, it is difficult to not only carry out the thickness control of the coating layer with high accuracy but also carry out the partial thickness adjustment in a circumferential direction of the combustion chamber bore with high accuracy.

In view of the conventional technique, the present invention has been made to provide a metal laminate cylinder head gasket which utilizes the formation of a resin layer by injection molding in order to adjust the thickness of the sealing portion of the metal laminate cylinder head gasket with high accuracy, since by the injection molding, not only the thickness of the resin layer can be adjusted with high accuracy but also the partial thickness can be adjusted with high accuracy.

Further objects and advantages of the invention will be apparent from the following description of the invention.

### SUMMARY OF THE INVENTION

In order to solve the above-mentioned problem, as for a metal laminate cylinder head gasket according to the present invention, in a sealing portion which seals around a combustion chamber bore, a resin layer for adjusting the surface pressure is additionally provided in one sheet of the end portion on a combustion chamber bore side among laminated metal plates by injection molding so as to be integrated with the end portion thereof.

In a preferred embodiment of the metal laminate cylinder head gasket according to the invention, a number of minute concave portions are formed in a providing portion of the resin layer of the metal plates beforehand, and the resin of the resin layer by injection molding is structured so as to be pressed into the concave portions thereof as well.

Additionally, in the preferred embodiment of the metal laminate cylinder head gasket according to the invention, in order to prevent the damage to the resin layer from the heat of the combustion chamber, the resin layer and the end portion of the metal plate to which the resin layer is provided are structured so as to be sandwiched by a folded portion of other laminate metal plate or a grommet.

The resin layer of the metal laminate cylinder head gasket of the invention can be formed as a unit which straddles both surfaces of the metal plate. Also, the thickness of the resin layer can be adjusted according to a partial surface pressure which is produced around the combustion chamber bore.

In the metal laminate cylinder head gasket including the above-mentioned structure, the resin layer for adjusting the surface pressure is formed in the sealing portion around the combustion chamber bore by injection molding which can not only adjust the thickness of the resin layer with high accuracy but also adjust the partial thickness with high accuracy. As a result, the thickness of the resin layer can be adjusted with high accuracy, and an appropriate sealing around the combustion chamber bore can be carried out.

Also, the resin layer and the end portion of the metal plate to which the resin layer thereof is provided, are sandwiched by the folded portion of the other laminate metal plate or the grommet, so that the damage to the resin layer due to the heat of the combustion chamber can be prevented.

According to the metal laminate cylinder head gasket of the invention as explained above, due to the injection molding of resin, the resin layer for adjusting the surface pressure in the sealing portion around the combustion chamber bore can be formed with high accuracy.

### BRIEF DESCRIPTION OF THE DRAWINGS

FIG. 1 is a plan view showing an overall configuration of a first embodiment of a metal laminate cylinder head gasket according to the present invention;

FIG. 2 is an enlarged cross-sectional view taken along line 2-2 in FIG. 1 in the first embodiment of the present invention;

FIG. 3 is a cross-sectional view of the essential parts in the same position as in FIG. 2 in the second embodiment of the present invention;

FIG. 4 is a cross-sectional view of the essential parts in the same position as in FIG. 2 in the third embodiment of the present invention;

FIG. 5 is a cross-sectional view of the essential parts in the same position as in FIG. 2 in the fourth embodiment of the present invention; and

FIG. 6 is an enlarged sectional view of an additional portion of a resin layer by injection molding in the first to fourth embodiments of the present invention.

### DETAILED DESCRIPTION OF PREFERRED EMBODIMENTS

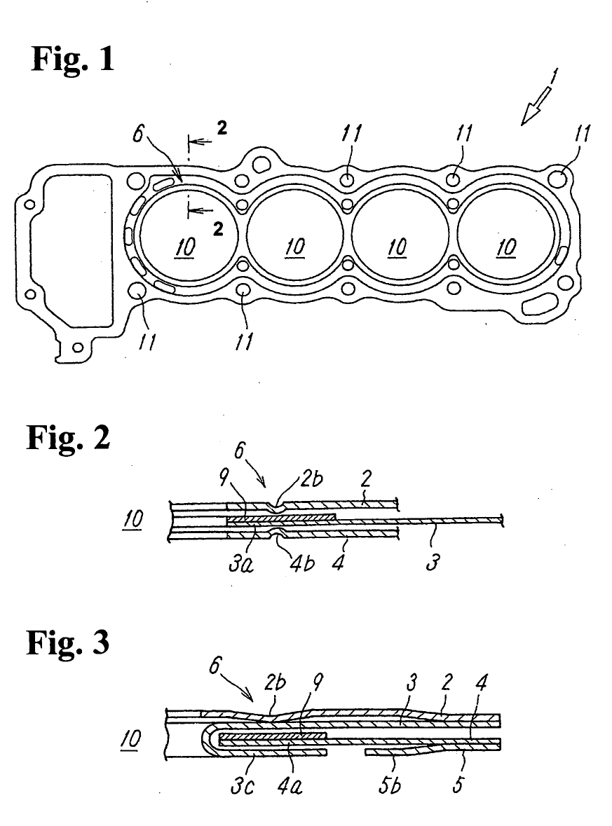

FIG. 1 shows an overall configuration of an embodiment of a metal laminate cylinder head gasket according to the present invention. The metal laminate cylinder head gasket 1, as shown in FIGS. 2 to 6, is formed by laminating a plurality of metal plates 2 to 5, provided with a plurality of combustion chamber bores 10 linearly aligned, and also provided with bolt holes 11 disposed at an equal distance around each combustion chamber bore 10.

FIG. 2 shows an example (first embodiment) taken along line 2-2 in FIG. 1. As for a sealing portion 6 which seals around the combustion chamber bore 10, a resin layer 9 for adjusting the surface pressure is additionally provided in an end portion 3a on a combustion chamber bore 10 side of one sheet of metal plate 3 which is the inner layer among the laminated metal plates 2, 3, 4, so as to be integrated with the end portion 3a by injection molding. Incidentally, in the metal plates 2, 4 which are both external layers, beads 2b, 4b, whose top portions abut against the resin layer 9 and the side end portion 3a of the metal plate 3 to which the resin layer 9 is additionally provided, are provided.

As shown in FIG. 6, as for the resin layer 9, a number of minute concave portions 8 are formed in the end portion 3a which is the providing portion of the resin layer 9 in the metal plate 3 beforehand. When the resin layer 9 is formed by the above-mentioned injection molding, the resin is pressed into the concave portions 8 as well. As a result, the resin layer 9 can be firmly fixed to the end portion 3a of the metal plate 3.

In the metal laminate cylinder head gasket including the above-mentioned structure, since the resin layer 9 is formed by injection molding with high pressure, not only the thickness thereof can be adjusted with high accuracy but also the partial thickness can be adjusted with high accuracy even around the combustion chamber bore 10. For example, near the bolt holes 11, where the effect of a fastening force of a bolt which is fastened in the bolt holes 11 is strongly affected, the surface pressure of the sealing around the combustion chamber bore 10 can be set adequately such that the surface pressure is increased by slightly reducing the thickness of the resin layer and slightly increasing the thickness of the resin layer 9 between two bolt holes 11.

FIG. 3 shows a cross-sectional shape of another cylinder head gasket (second embodiment) in a portion corresponding to the 2-2 position in FIG. 1. In the second embodiment, as for the sealing portion 6 around the combustion chamber bore 10, the resin layer 9 for adjusting the surface pressure is additionally provided in an end portion 4a on the combustion chamber bore 10 side of one sheet of metal plate 4 which is the inner layer among the laminated four sheets of metal plates 2, 3, 4, 5, so as to be integrated with the end portion 4a by injection molding. Then, the resin layer 9 and the end portion 4a of the metal plate 4 to which the resin layer 9 thereof is provided are sandwiched inside a folded portion 3c of the metal plate 3 which is the other laminated metal plate of the inner layer. Thereby, the damage to the resin layer 9 due to the heat of the combustion chamber bore 10 can be prevented.

Incidentally, the metal plate 2 as one of the external layers includes a bead 2b, whose top portion abuts against the resin layer 9 through the metal plate 3 as the inner layer. Also, as for the metal plate 5 of the other of the external layers, a half bead 5b is provided in the end of the metal plate 5 facing the end of the folded portion 3c of the metal plate 3.

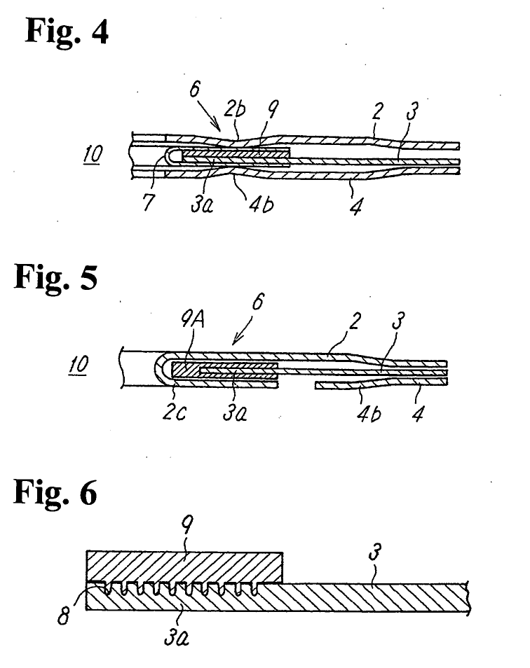

FIG. 4 shows a cross-sectional view of another cylinder head gasket (third embodiment) of the portion corresponding to the 2-2 position in FIG. 1. In the third embodiment, as for the sealing portion 6 around the combustion chamber bore 10, the resin layer 9 for adjusting the surface pressure is provided in the end portion 3a on the combustion chamber bore 10 side of the sheet of the metal plate 3 which is the inner layer among the laminated three sheets of metal plates 2, 3, 4, so as to be integrated with the end portion 3a by injection molding. Then, the resin layer 9 and the end portion 3a of the metal plate 3 to which the resin layer 9 is provided are sandwiched inside a grommet 7. Thereby, the damage to the resin layer 9 due to the heat of the combustion chamber bore 10 can be prevented. Incidentally, in the fourth embodiment, in the metal plates 2, 4 of both external layers, the beads 2b, 4b whose top portions abut against the grommet 7, are provided.

FIG. 5 shows a cross-sectional shape of another cylinder head gasket (fourth embodiment) of the portion corresponding to the 2-2 position in FIG. 1. In the fourth embodiment, as for the sealing portion 6 around the combustion chamber bore 10, a resin layer 9A which is formed as a unit straddling both surfaces of the metal plate 3, is provided in the end portion 3a on the combustion chamber bore 10 side of the sheet of metal plate 3 which is the inner layer among the laminated three sheets of metal plates 2, 3, 4, so as to be integrated with the end portion 3a by injection molding. Then, by sandwiching the resin layer 9A inside a folded portion 2c of the metal plate 2 which is one of the external layers, the resin layer 9A is blocked from the heat of the combustion chamber bore 10.

Incidentally, as for the metal plate 4 which is the other of the external layers, the half bead 4b which is provided in the end thereof faces the end of the folded portion 2c of the metal plate 2.

Even in the cylinder head gaskets of the second to fourth embodiments, the thickness of the resin layers 9, 9A can be adjusted as in the case of the first embodiment according to the partial surface pressure which is produced around the combustion chamber bore 10.

Also, since the other structures and operations in the second to fourth embodiments are the same as those of the first embodiment, explanations thereof are omitted.

The disclosure of Japanese Patent Application No. 2009-048994, filed on Mar. 3, 2009, is incorporated in the application.

While the invention has been explained with reference to the specific embodiments of the invention, the explanation is illustrative and the invention is limited only by the appended claims.

What is claimed is:

1. A metal laminate cylinder head gasket, comprising;
a plurality of metal plates laminated together to form the cylinder head gasket, and having at least one cylinder bore therein, and
an injection molded resin layer for adjusting a surface pressure of the gasket around the at least one cylinder bore, said resin layer being integrally formed on one of the metal plates to surround the cylinder bore to seal therearound.

2. A metal laminate cylinder head gasket according to claim 1, wherein said one of the metal plates includes a number of minute concave portions formed at portions where the resin layer is formed so that resin of the resin layer is pressed into the concave portions by injection molding.

3. A metal laminate cylinder head gasket according to claim 1, wherein one of the metal plates includes a folded portion facing the cylinder bore, the metal plate with the resin layer is sandwiched by the folded portion of the metal plate not to directly face the cylinder bore.

4. A metal laminate cylinder head gasket according to claim 1, wherein said resin layer is formed on each of two surfaces of the one of the metal plates, said resin layer on each of the two surfaces being integrally connected at an end of the one of the metal plates together as one unit.

5. A metal laminate cylinder head gasket according to claim 1, wherein the thickness of said resin layer is adjusted according to a partial surface pressure which is produced around the combustion chamber bore.
